(19) United States
(12) Patent Application Publication
(10) Pub. No.: US 2014/0069715 A1
(43) Pub. Date: Mar. 13, 2014

(54) INSULATOR ARRANGEMENT

(71) Applicants: Martin Schuhmacher, Herzogenaurach (DE); Gertrud Schumacher, Herzogenaurach (DE)

(72) Inventors: Martin Schuhmacher, Herzogenaurach (DE); Gertrud Schumacher, Herzogenaurach (DE)

(73) Assignee: SIEMENS AKTIENGESELLSCHAFT, MUENCHEN (DE)

(21) Appl. No.: 13/979,058

(22) PCT Filed: Jan. 6, 2012
(86) PCT No.: PCT/EP2012/050173

§ 371 Date: Sep. 27, 2013

(30) Foreign Application Priority Data
Jan. 10, 2011 (DE) 10 2011 008 451.7

(51) Int. Cl. H01B 7/02

(52) U.S. Cl. CPC H01B 7/02
USPC 174/70 R; 174/113 R; 174/102 R

(57) ABSTRACT

An insulator arrangement includes an insulating body. A phase conductor passes through the insulating body. The phase conductor is surrounded by an electrode. A gap is formed to pass through the electrode, in particular completely. The gap interrupts a completely closed circumference of the electrode.

The invention relates to an insulator arrangement having an insulating body and at least one phase conductor which penetrates the insulating body in the direction of a main axis from a first face side to a second face side and which is substantially encompassed by an electrode perpendicular to the main axis.

An insulator arrangement of this kind is disclosed for example in application DE 2 325 449. An insulating body of the insulator arrangement here is penetrated by a phase conductor which is encompassed by an electrode. The electrode here is part of a capacitor arrangement for determining an electrical voltage applied to the phase conductor.

As a rule, insulator arrangements have a limited spatial volume. Because of the comparatively high costs for high-quality insulating materials for constructing the insulating body, it is desirable to reduce their volume. The installation space available for accommodating an electrode is correspondingly reduced.

The object of the invention is therefore to use the installation space available in an insulator arrangement more effectively.

According to the invention, with an insulator arrangement of the kind mentioned in the introduction, the object is achieved in that the electrode is penetrated by a gap, in particular completely penetrated, which interrupts a completely closed revolution of the electrode.

For example, an electrode can run around the phase conductor in an almost closed manner, wherein ends of the electrode which face one another border a gap. In doing so, the gap interrupts a completely closed revolution of the electrode, wherein a distance between the surfaces of the electrode which border the gap across the gap is considerably less than a path between the surfaces which border the gap in the peripheral direction via the electrode body. At the same time, the gap can extend only partially into the electrode body, thus creating a point of discontinuity in the circumference of the electrode, but the electrode is not completely penetrated. The gap reduces the cross section of the electrode in its circumference. In doing so, the gap extends into the electrode body in the form of a piercing. At the same time, it is advantageous when the gap extends completely through the electrode body. The gap should have a component which is aligned perpendicular to the circumferential path of the electrode so that the electrical resistance in the circumference of the electrode is increased by the gap. The gap should be constructed in the form of a slot so that the gap protrudes into the electrode body in a slot-like manner. Preferably, the gap should completely penetrate the electrode body. However, it can be provided that the gap only partially penetrates the electrode and thus partially interrupts a completely closed revolution.

At the same time, the gap should be designed so that the surfaces of the electrode which border the gap are aligned approximately parallel with one another. The surfaces can be provided with appropriate profiling, wherein a profiling of the one surface which borders the gap should be designed approximately identical but opposite to a profiling of the other surface which borders the gap. For example, it can therefore be provided that the gap penetrates the electrode in the form of steps, in an arc, in an undulating manner, in a rolling manner, in the form of a spiral, etc.

The electrode acts as a field concentrating device, in particular for magnetic and/or electrical fields.

Rotationally symmetrical structures of the electrode in particular have been shown to be advantageous, wherein the cross section can vary in the circumferential direction. For example, the electrode can have rectangular, circular or curved cross sections. At the same time, the gap penetrates the electrode in the direction of the cross section, i.e. the gap reduces the cross section or the gap penetrates the cross section completely so that the surfaces bordering the gap correspond at least partially or completely to a cross section of the electrode. As well as an annular circumferential path of the electrode, it is also possible to have the electrode follow a path in the form of a polygon, oval etc. The electrode can be designed as a cut strip electrode for example.

A further advantageous embodiment can provide that the electrode is penetrated by the gap in a radial direction.

A radial path of the gap enables a gap to be formed which lies perpendicular to the circumferential direction of the electrode. The surfaces bordering the gap can lie at least in sections perpendicular to the circumferential path of the electrode. Surfaces of this kind are particularly suitable for making field lines, which are concentrated by means of the electrode, pass through the gap in an approximately parallel manner and enter and leave the surfaces at right angles. The electrode can act as a magnetic field concentrator, for example, wherein magnetic field lines are concentrated within the electrode and bundled in the circumferential direction of the electrode. The magnetic field lines leave the one surface bordering the gap and enter the other surface bordering the gap so that the gap is likewise penetrated by the magnetic field lines. At the same time, the gap should preferably be penetrated by the magnetic field lines as homogenously as possible. When the gap partially pierces the electrode, it is possible to guide a portion of the field lines in the electrode body past the gap and only allow remaining portions to pass through the gap. A distribution of the field lines can be controlled by the ratio of the remaining cross section of the electrode to the gap and by the choice of material, gap width, gap shape etc.

A further advantageous embodiment can provide that a blind-hole-like pocket which extends in the direction of the gap opens out into one of the sleeve surfaces connecting the face sides of the insulating body.

A blind-hole-like pocket within the insulating body allows access to the gap through the insulating body. Depending on the requirement, the pocket can extend into the gap or terminate in the vicinity thereof. This makes it possible, for example, to accommodate further components in the region of the gap. In doing so, it can be provided that surfaces of the electrode bordering the gap border at least sections of the blind-hole-like pocket. However, it can also be provided that the blind-hole-like pocket is completely bordered by insulating material of the insulating body. At the same time, it is advantageous when the blind-hole-like pocket protrudes into the gap. This enables measuring instruments, for example, to be inserted in the gap of the electrode. At the same time, a cover of the surfaces of the electrode bordering the gap can be provided with insulating material in the region of the gap.

Access to the blind-hole-like pocket via a sleeve side of the insulating body enables the face sides of the insulator to be kept free from inhomogeneities such as openings, sealing caps or the like, so that these areas can be dielectrically stressed. Furthermore, the insulator arrangement can be connected to further components on the face side so that, even when the insulator arrangement is covered on the face side, access is still guaranteed on the sleeve side. This enables components arranged in the blind-hole-like pocket to be retrofitted, replaced or repaired for example.

Advantageously, it can further be provided that contact can be made with the electrode by means of an electrically conducting connection which penetrates the insulating body.

Contact can be made with the electrode by means of an electrically conducting connection even when said electrode is embedded in the insulating body. In doing so, the contact region between electrode and electrically conducting connection can be completely covered by insulating material of the insulating body. This is of advantage particularly when the electrode is completely embedded. The contact region is protected from external influences and from vibrations etc. thus making it more difficult for the electrically conducting connection to come loose from the electrode. Furthermore, the electrically conducting connection makes it possible to apply a particular electrical potential to the electrode from the outside, i.e. from outside the insulating body or from outside the insulator arrangement, and, if necessary, to make this potential variable. At the same time, it has been shown to be advantageous to apply ground potential to the electrode. In the event that the electrode is electrically charged, this makes it possible to have charge carriers diverted to ground potential via the electrically conducting connection. At the same time, the electrically conducting connection should be sized so that an appropriate discharge current can be carried continuously by the electrically conducting connection. The electrically conducting connection can advantageously leave the insulating body on a sleeve side.

At the same time, the discharge current can be evaluated by means of a measuring device. This makes it possible to infer the voltage loading of the phase conductor from the magnitude of the discharge current and, if appropriate, from its phasing or from other characteristic elements. When an electrical voltage is applied, i.e. a potential which differs from the ground potential, the phase conductor is able to carry an electrical current which is driven by this voltage. The voltage loading of the phase conductor can lead to a charging of the electrode, wherein this charge can be dissipated via the electrically conducting connection. The discharge current is an image of the driving voltage on the phase conductor, thus enabling the voltage to be measured indirectly via the discharge current.

Furthermore, it can advantageously be provided that the insulating body is enclosed by an electrically conducting frame, in particular a metal frame, which is connected to the electrode by means of an electrically conducting connection.

The use of a frame around the insulating body enables the insulating body to be protected against mechanical influences. In particular, a sleeve area of the insulating body which is small in extent compared with a face side is protected against acting forces by the frame. By way of example, the frame can be designed as a hollow cylinder with annular cross sections. On the inside of the sleeve, the frame can have profiling, for example a circumferential groove, in which the insulating body can be placed and positively locked. An electrically conducting design of the frame enables ground potential to be applied to the frame, and the insulating body therein to be dielectrically shielded. Furthermore, for example, the frame can serve to connect the insulator arrangement with other assemblies. As an example, the frame can have flange surfaces, by means of which the insulator arrangement can be flanged to a further flange for example. In addition, a metal frame has the advantage that an insulating body can be cast directly into the frame in order to produce the insulator arrangement. The frame therefore acts as so-called “stay-in-place formwork”.

An electrically conducting connection between frame and electrode enables the potential of electrode and frame to be equalized so that potential differences between frame and electrode can be compensated for. This region is therefore to be assessed as being free from fields. There can therefore also be no partial discharges in this region. This enables a dielectrically stable insulator arrangement to be formed. Furthermore, with an appropriately angularly rigid design of the electrically conducting connection between electrode and frame, it is possible to position frame and electrode relative to one another. This is of advantage particularly when the insulating body is to be cast into the frame in the course of a casting process.

However, it can also be provided that so-called frameless insulator arrangements are used. Insulator arrangements of this kind dispense with a separate frame so that the insulator arrangement is bounded by the insulating body itself. The insulating body can also be designed with flange surfaces, for example, in order to connect the insulator arrangement to further assemblies by means of flanging. The insulating body therefore undertakes the mechanical functions of a separate frame. This is referred to as a frameless insulator arrangement or an insulating body with integral frame.

Furthermore, it can advantageously be provided that the electrically conducting connection makes contact with the electrode in the region of the gap.

An electrically conducting connection can advantageously make contact with the electrode in the region of the gap. This makes it possible to monitor the electrically conducting connection and its condition, for example using a blind-hole-like pocket. For example, the electrically conducting connection can extend through the blind hole or form a wall which at least partially borders the blind hole. However, it can also be provided that the electrically conducting connection is completely embedded in the insulating material of the insulating body and makes contact with the electrode in the region of the gap.

Furthermore, it can advantageously be provided that a magnetic field measuring device protrudes into the gap.

As described above, the electrode, as a field concentration device, can bundle and concentrate magnetic fields for example. In the region of the gap, it is possible to measure magnetic field lines which pass from one surface bordering the gap to another surface bordering the gap and to obtain information relating to the magnetic field concentrated by means of the electrode. For this purpose, it can be provided, for example, that the electrode is formed from a soft magnetic material, for example a ferromagnetic material. As an example, Hall sensors can be used for the magnetic field measuring device. The magnetic field measuring device can be mounted, for example, on a finger which protrudes into the pocket of the insulating body so that the magnetic field measuring device can be easily positioned. Furthermore, this enables the magnetic field measuring device to be easily removed and fitted. At the same time, the magnetic field measured by the magnetic field measuring device can originate, for example, from an electric current flow flowing through one of the phase conductors. Advantageously, the magnetic field concentrated by the electrode should behave in proportion to the electric current flowing in the phase conductor. This enables an image of an electric current flowing in the phase conductor to be obtained by means of a magnetic field measuring device. In particular, proportionality should exist both with regard to magnitude and with regard to phase position of the electric current.

A further advantageous embodiment can provide that a current measuring device is arranged on the electrically conducting connection.

An electric current flowing within the phase conductor is usually driven by an electrical voltage. In doing so, the voltage can be a direct voltage or an alternating voltage which results in a corresponding direct current or alternating current flow. At the same time, charging phenomena, which can be dissipated via the electrically conducting connection, can occur at the electrode. In particular, charging phenomena of this kind can be easily dissipated when the electrode is grounded by means of the electrically conducting connection. If the resulting discharge current is used and measured, this is an indication of the voltage applied to the phase conductor. This enables the voltage of the phase conductor to be monitored by measuring the current in the electrically conducting connection. Depending on the type of discharge current measurement, quantitative information relating to the electrical voltage can also be determined.

At the same time, the electrically conducting connection is an easily accessible region, and faults can only occur in this region with difficulty. For example, when positioned within the insulating body, undesirable stray currents are not expected to occur. Accordingly, the formation of an image of an electrical voltage by means of a current measurement in the electrically conducting connection has good validity. In turn, different methods can be used for measuring the current. For example, a transformer principle can be used, wherein the electrically conducting connection can serve as the primary side and an appropriately arranged winding as the secondary side. However, alternative sensors can also be used. For example, fiber-optic sensors and also Hall sensors etc. can be used. A sensor for measuring the current in the electrically conducting connection and a sensor for measuring the magnetic field can be arranged within the same blind-hole-like pocket. The sensors can be positioned on a common finger and protrude into the blind-hole-like pocket. If the insulator arrangement is equipped with a frame, the electrically conducting connection can be arranged between electrode and frame. The current can also be measured within this section. However, it can also be provided that the electrically conducting connection penetrates the frame in an electrically insulated manner and the discharge current is measured outside the insulator arrangement. Further, it can be provided that the electrically conducting connection extends between electrode and frame, wherein the frame carries ground potential. In this case, the discharge current can also be measured in the ground conductor(s) of the frame.

It is particularly advantageous when the electrode is used both for current monitoring and for voltage monitoring of the phase conductor. This enables information relating to current and voltage in the phase conductor to be easily determined in a compact space. In doing so, it can be advantageous when the current and voltage measuring devices are fitted together in the blind-hole-like pocket of the insulating body. For example, current and voltage instruments can be arranged on a measuring finger fitted in the blind-hole-like pocket.

A further advantageous embodiment can provide that the phase conductor and the electrode are aligned coaxially with respect to the main axis.

A coaxial alignment of electrode and phase conductor with respect to the main axis is of advantage particularly when a single phase conductor penetrates the insulating body and, if appropriate, the insulating body is enclosed by an annular frame. If the phase conductor is now arranged coaxially with respect to the main axis of the frame and therefore to the main axis of the insulator arrangement, and the electrode is still arranged coaxially with respect to the main axis and encompassing the phase conductor, this results in a shell-like construction in which a homogenous field distribution is to be expected. Constructions of this kind can advantageously be used, for example, in gas-insulated switchgear systems which have single-phase gas insulation. A phase conductor is fed inside a tubular encapsulation housing, wherein an insulator arrangement is arranged on the face side of the encapsulation housing and the phase conductor of the encapsulation housing makes electrically conducting contact with the phase conductor of the insulator arrangement. The interior of the encapsulation housing is filled with an electrically insulating gas.

A further advantageous embodiment can provide that a plurality of phase conductors distributed on a circular path about the main axis penetrate the insulating body and in each case are encompassed by an electrode substantially perpendicular to the main axis.

A plurality of phase conductors can, for example, be used for the transmission of a polyphase AC electrical power transmission network. In particular, the use of three phase conductors has become established here. For example, it is advantageous to arrange the different phase conductors distributed on a circular path about the main axis. In particular, a uniform distribution is to be aimed for, wherein, when exactly three phase conductors are used, these should mark the corners of an equilateral triangle when viewed in the direction of the main axis. In doing so, each of the phase conductors is enclosed by a separate electrode, wherein the electrodes are electrically insulated from one another and are arranged on the insulating body, wherein however each electrode can be connected to ground potential by means of an electrically conducting connection described above and therefore the electrodes can be indirectly connected to one another. In a similar manner, the electrodes can be completed by a blind-hole-like pocket, a plurality of measuring devices etc.

In doing so, it can advantageously be provided that each of the electrodes is penetrated by a gap which runs substantially radially with respect to the main axis.

Using gaps in the electrodes which in each case are aligned radially with respect to the main axis results in a structure with which the gaps are in each case uniformly spaced and at a large distance from one another. This makes it possible to space individual measuring devices as far as possible from one another and to prevent them having a mutual effect on one another. Furthermore, this makes it possible to arrange the gap comparatively close to an edge of the insulating body so that electrically conducting connections between the respective electrodes through the insulating body turn out to be comparatively short. Preferably, the gaps should lie in the regions of the electrodes which face the edge or frame of the insulator arrangement.

Regardless of the number of electrodes and the number of phase conductors, a separate or also an integral frame should be aligned coaxially with the main axis. One or more electrodes or one or more phase conductors can then be positioned symmetrically distributed inside the frame. In doing so, the electrodes are in each case arranged electrically insulated from each of the phase conductors, and an electrical connection of the electrodes to one another is provided exclusively by means of the respective electrically conducting connection. Direct electrical connections of the electrodes to one another are not provided. In the same way, a direct connection of the electrodes to any separate frame which may be present is not provided. An electrical connection and potential transmission between the electrodes or between the electrodes and a frame is only possible by means of the electrically conducting connection between the respective electrodes.

Advantageously, it can further be provided that the frame runs coaxially around the main axis.

A coaxial arrangement enables a most homogenous shielding effect of the frame to be used.

Furthermore, it can advantageously be provided that the electrode(s) are completely enclosed by the insulating body.

Completely embedding the electrodes in the insulating body enables the electrodes to be protected from direct external influences. In doing so, complete enclosure should be provided in such a way that there is no immediate access to the electrodes on the face side and on the sleeve side. However, complete enclosure of the electrodes expressly includes access thereto, for example by means of connecting points in the blind-hole-like pocket or by means of other access points.

Advantageously, it can further be provided that the phase conductor(s) form an angularly rigid bond with the insulating body.

An angularly rigid bond between phase conductors and insulating body enables the phase conductors to be supported and positioned by means of the insulating body. On the one hand, this enables the insulating body to act as a supporting insulator and, on the other, to be used for monitoring the condition of the phase conductor. For example, it can be provided that a frame of the insulator arrangement and/or the insulating body itself is fixed to a flange, by means of which the insulating body supports the phase conductors relative to the flange. In this way it is possible, for example, to fix an insulator arrangement on tubular openings on the face side of encapsulation housings and to use the insulator arrangement to seal flange openings in the face sides of encapsulation housings of gas-insulated electrical power transmission devices. The bond between phase conductor and insulating body can be designed to be fluid-tight.

Furthermore, it can advantageously be provided that the insulating body is in the form of a disk.

In particular, a disk-shaped insulating body includes insulating bodies which have a smooth structure. Insulating bodies are also disk-shaped however when the insulating body is dished in the form of a pot, for example. A disk-shaped insulating body has a planar extension, wherein the planar extension is penetrated by at least one phase conductor. Disk-shaped insulating bodies are therefore able, for example, to span and cover flange openings in encapsulation housings.

A further advantageous embodiment can provide that the disk-shaped insulating body has profiling.

A creepage path along the surface of the insulating body, for example between a phase conductor and a frame, can be extended by means of profiling. By way of example, profiling can include ribbing, recesses in the insulating body, etc.

A further advantageous embodiment can provide that an access to the blind-hole-like pocket is provided via the frame.

Advantageously, the frame can enclose a sleeve surface of the insulating body so that the sleeve surface is protected against external influences. If an access is now provided via the frame, then the blind-hole-like pocket can still be fitted with components, such as measuring devices or similar, or replacement thereof can be carried out, even after completion of the insulating body with a frame. Particularly when the insulator arrangement is flanged on the face side, access to the insulating body is only possible with considerable dismantling effort. If an appropriate access is provided in the frame, then access to the blind-hole-like pocket from the outside is possible even in the assembled state and, if necessary, also in the live state of the phase conductor(s). For this purpose, the frame can have a sealable access hole, for example, wherein a sealing element can also be used to feed out measuring cables or similar from the interior of the blind-hole-like pocket.

In the following, an exemplary embodiment of the invention is shown schematically in a drawing and subsequently described in more detail.

In the drawing:

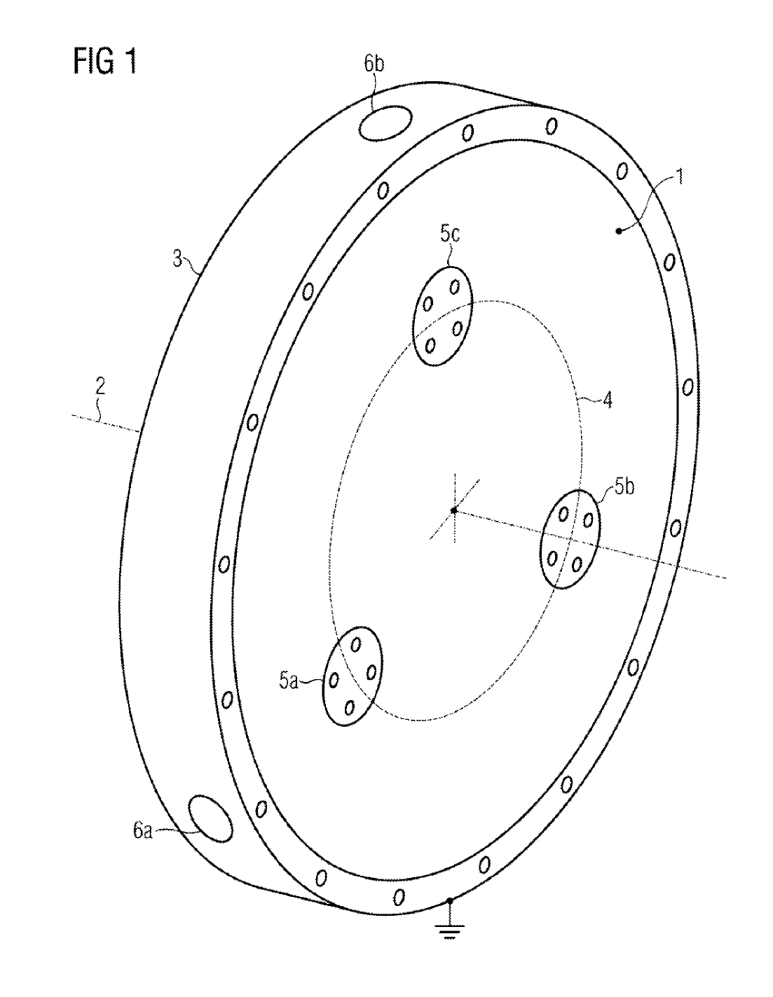

FIG. 1 shows a perspective view of an insulator arrangement,

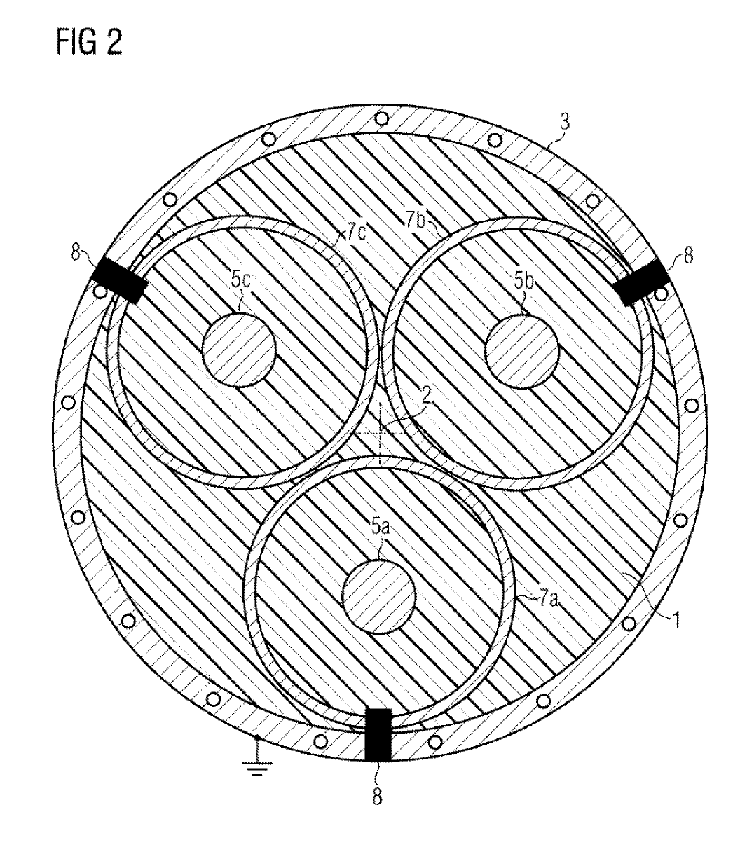

FIG. 2 shows a cross section through the insulator arrangement,

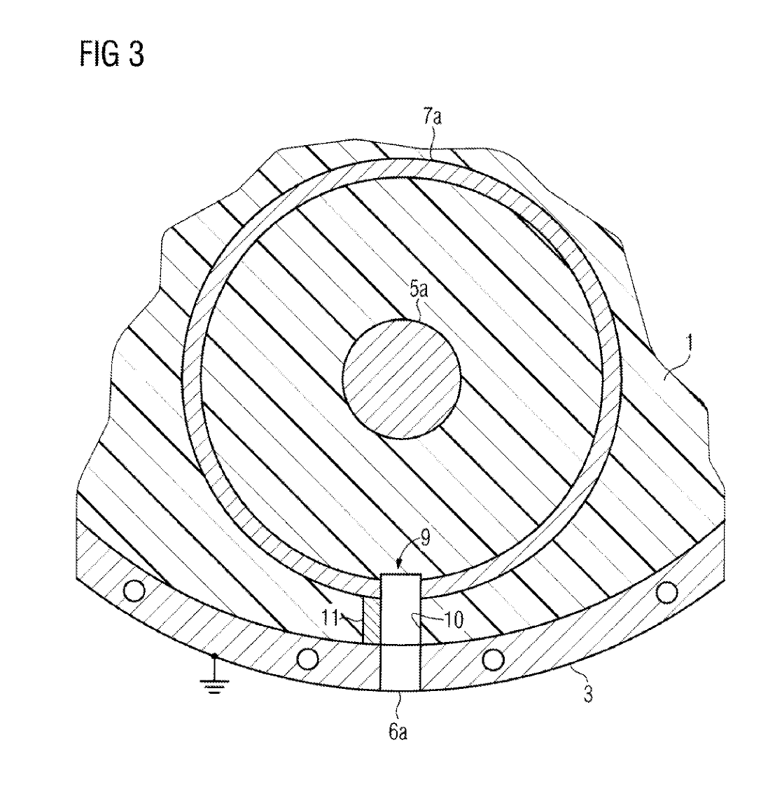

FIG. 3 shows an enlarged representation of a part of FIG. 2,

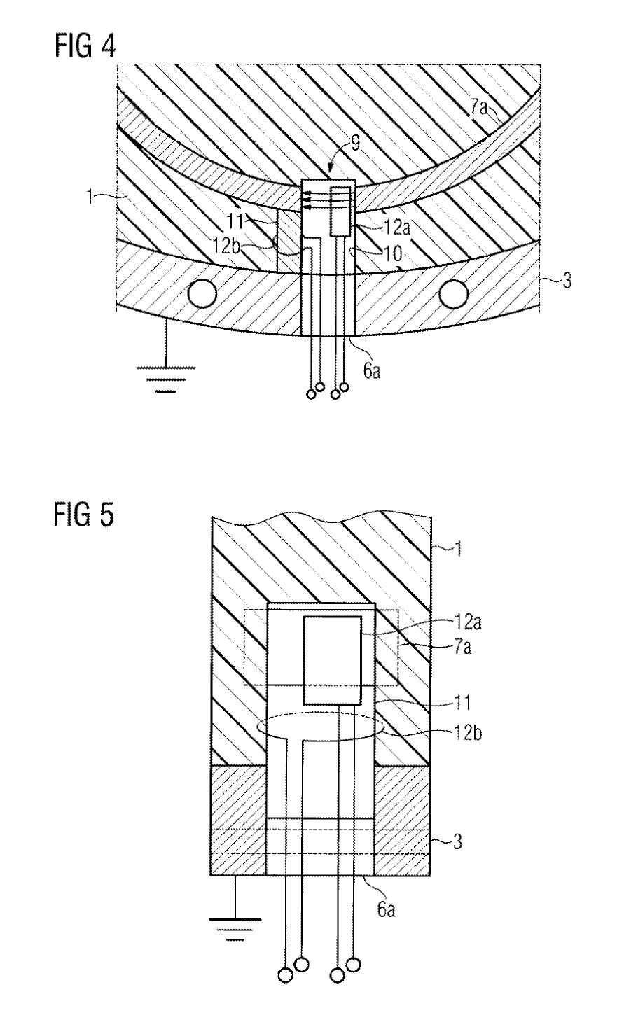

FIG. 4 shows an enlarged representation of a part of FIG. 3,

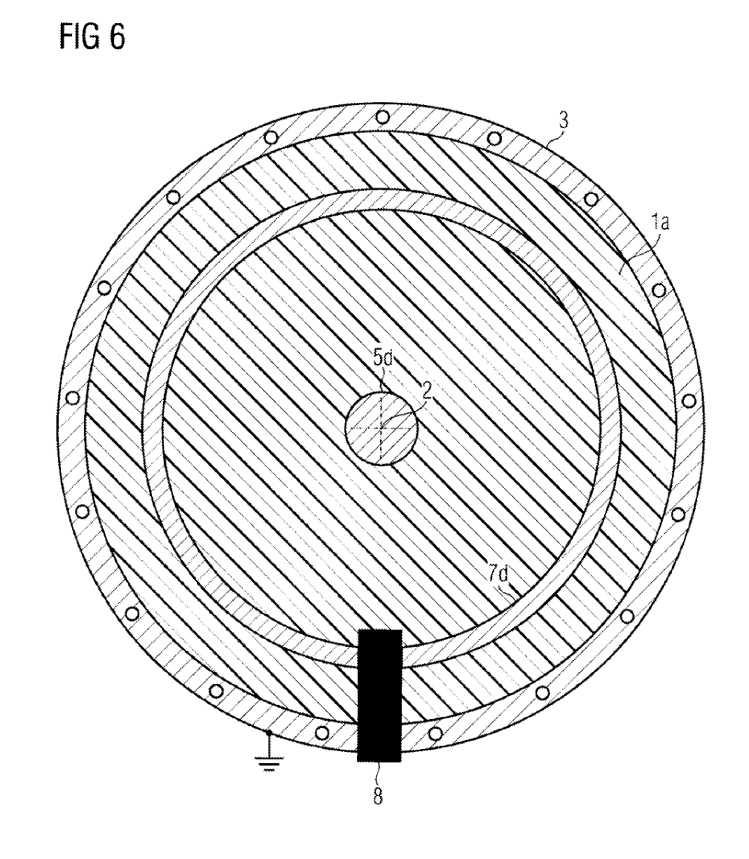

FIG. 5 shows a section lying perpendicular to the plane of the drawing of FIG. 4, and

FIG. 6 shows an alternative embodiment of an insulator arrangement in cross section.

The insulator arrangement shown in perspective in FIG. 1 has an insulating body 1. In the present case, the insulating body 1 is designed in the form of a disk and has a circular contour. The insulating body 1 is penetrated by a main axis 2. The insulating body 1 is enclosed by a frame 3. In the present case, the frame 3 is designed in the form of an annulus and is aligned coaxially with respect to the main axis 2. The frame 3 encloses the insulating body 1 of the insulator arrangement on the sleeve side and borders the face sides which extend substantially transversely, in particular perpendicular to the main axis 2. The face sides likewise have a circular contour in each case. Alternatively, the use of a frame 3 can be dispensed with in the exemplary embodiment according to FIG. 1 as in the representations of the further figures. The form and mechanical effect of the frame 3 are integrated within the insulating body 1.

A first phase conductor 5a, a second phase conductor 5b and a third phase conductor 5c are arranged on a circular path 4 which lies coaxially with respect to the main axis 2. In the figure, the circular path 4 is shown merely for symbolic purposes. The phase conductors 5a, 5b, 5c are designed in substantially the same way and penetrate the insulating body 1 of the insulator arrangement in the direction of the main axis 2 in a fluid-tight manner. At the same time, the phase conductors 5a, 5b, 5c preferably have a rotationally symmetrical structure in each case, wherein the axes of rotation of the phase conductors 5a, 5b, 5c are aligned parallel to one another, and the main axis 2 likewise lies parallel to the axes of rotation. The phase conductors 5a, 5b, 5c can have a cylindrical form, for example, wherein circular cover surfaces lie flush in the face sides of the insulating body 1.

In the present case, the frame 3 is designed as a frame with a substantially U-shaped profile which opens in the direction of the main axis 2 and passes around said axis, wherein an identical but opposite molding of the insulating body 1 projects into the U-shaped profiling resulting in an angularly rigid bond between insulating body 1 and the frame 3. The phase conductors 5a, 5b, 5c are fixed relative to the frame 3 via the insulating body 1. The frame 3 has a plurality of recesses which are aligned substantially parallel to the main axis 2 and by means of which the frame 3 and therefore the whole insulator arrangement can be flanged to an identical but opposite molded flanged by means of bolts, for example. A flange of this kind can, for example, be arranged on a pressure-tight encapsulation housing of a gas-insulated switchgear system, so that this flange is spanned and covered by means of the insulator arrangement. A fluid-tight connection can be made between the insulator arrangement and the flange by means of an appropriate sealing element. Furthermore, the frame 3, the insulating body 1 and the phase conductors 5a, 5b, 5c can in each case be connected to one another in a fluid-tight manner so that the insulator arrangement can also be used as a fluid-tight flange seal, wherein the phase conductors 5a, 5b, 5c penetrate the insulator arrangement in the direction of the main axis 2 and thus enable electrical contact to be made with the phase conductors located inside the encapsulation housing.

Furthermore, access openings 6a, 6b are shown in FIG. 1. The access openings 6a, 6b extend through the frame 3 in a substantially radial direction, resulting in an access to a sleeve surface of the insulating body 1 via the access openings 6a, 6b. The access openings 6a, 6b can be sealed by means of sealing elements, for example.

In an alternative embodiment of the insulator arrangement shown in FIG. 1, alternative forms for the frame and alternative forms for the first, second and third phase conductors 5a, 5b, 5c and for the insulating body 1 etc. can also be provided. In particular, the number of phase conductors 5a, 5b, 5c can vary. When using a single phase conductor, this can be positioned coaxially with respect to the main axis 2 centrally within the insulating body 1 and within the frame 3 for example. A cross section through an alternative embodiment of this kind is shown schematically in FIG. 6.

FIG. 2 shows a section through the insulator arrangement disclosed in FIG. 1. Here, the section plane lies perpendicular to the main axis 2. The frame 3, which in section shows the bottom of the U-shaped profiling, can be seen in FIG. 2. The three phase conductors 5a, 5b, 5c are also shown. The insulating body 1 is a cast resin insulating body, for example, which has been introduced into the frame 3 in the liquid state and thus produces a fluid-tight bond between frame 3 and phase conductors 5a, 5b, 5c.

A first electrode 7a, a second electrode 7b and a third electrode 7c are embedded in the insulating body 1 in each case coaxially with respect to the three phase conductors 5a, 5b, 5c. In the present case, the electrodes 7a, 7b, 7c have an annular structure, wherein the electrodes 7a, 7b, 7c have a rectangular cross section along their circumference. The cross section of the electrodes 7a, 7b, 7c and their shape can vary however. The electrodes 7a, 7b, 7c are positioned at a distance from one another, wherein intermediate spaces between the electrodes 7a, 7b, 7c and between the electrodes 7a, 7b, 7c and the respective phase conductors 5a, 5b, 5c are filled by the insulating body 1. In FIG. 2, blocks 8 are shown symbolically in those regions of the electrodes 7a, 7b, 7c which face the frame 3. The structure of the blocks 8 is described below by way of example with reference to FIGS. 3, 4 and 5.

FIG. 3 shows an enlargement of the first electrode 7a and the first phase conductor 5a which is enclosed by the first electrode 7a. Like the insulating body 1, only a section of the frame 3 is shown. The electrode 7a encompasses the first phase conductor 5a, wherein electrode 7a and phase conductor 5a are in each case designed in a rotationally symmetrical manner. The first electrode 7a follows a circular path so that the electrode 7a and the first phase conductor 5a are arranged coaxially with respect to one another. The electrode 7a has a gap 9 in the region thereof which faces the frame 3 or the edge of the insulating body 1. In the present case, the gap 9 completely penetrates the first electrode 7a. It can however also be provided that the electrode 7a is only partially penetrated by a gap. In the present case, the walls of the first electrode 7a which border the gap 9 are designed to be smooth, wherein the gap 9 extends radially through the wall of the first electrode 7a in the direction of the first phase conductor 5a.

In the present case, a blind-hole-like pocket 10 which extends into the gap 9 is formed in the insulating body 1. At the same time, the blind-hole-like pocket 10 is aligned radially with respect to the phase conductor 5a and to the main axis 2. The blind-hole-like pocket 10 can have different cross sections. For example, the pocket 10 can have a circular cross section, an oval cross section and a rectangular cross section or a cross section of a different shape. At the same time, the blind-hole-like pocket 10 can extend completely through the gap 9 or only partially penetrate the gap 9 or merely extend as far as the gap 9, wherein the pocket 10 however does not project into the gap 9. In the latter case, the gap 9 can be filled with insulating material of the insulating body 1. It can however also be provided that the pocket 10 extends into the gap 9 and surfaces of the first electrode 7a which border the gap 9 also border walls of the blind-hole-like pocket 10. It can however also be provided that surfaces of this kind are covered by a layer of insulating material.

An electrically conducting connection 11, by means of which the first electrode 7a is connected to the frame 3 in an electrically conducting manner, is provided in the region of the gap 9. At the same time, the electrically conducting connection can be designed in such a way that assemblies provided for forming the connection border at least sections of the blind-hole-like pocket 10. It can however also be provided that the electrically conducting connection 11 is embedded in the insulating body 1 so that the blind-hole-like pocket 10 enables no direct access to the electrically conducting connection 11. In the event that a frame 3 is dispensed with, the electrically conducting connection 11 is fed at least to the edge of the outer circumference of the insulating body 1. Here, contact can be made with ground potential for example.

An access opening 6a of the frame 3 is aligned flush with the opening of the blind-hole-like opening 10 so that an access to the blind-hole-like hole from a radial direction is provided even when the insulating body 1 is completed with a frame 3. By way of example, the frame 3 can be made from an electrically conducting material, for example a metal, wherein this frame 3 should preferably carry ground potential. The ground potential of the frame 3 can also be transmitted to the first electrode 7a via the electrically conducting connection 11.

The first electrode 7a is used as a field concentration device, wherein preferably magnetic fields are to be concentrated by means of the first electrode 7a. As such, the first electrode 7a can be made of ferromagnetic material. Soft iron materials are particularly suitable for forming the first electrode 7a. Comments relating to the described first electrode 7a and the further assemblies associated with this electrode can also be applied in a similar manner to the further electrodes and insulator arrangements identified in this document.

For example, referring to FIG. 4, the blind-hole-like pocket 10 is shown filled with a first measuring device 12a and a second measuring device 12b. The two measuring devices 12a, 12b are merely shown by way of example. It can be provided that the measuring devices 12a, 12b constitute parts of a superimposed measuring apparatus, wherein, for example, evaluation units etc. can be located outside the blind-hole-like pocket 10.

The first electrode 7a with the gap 9 functions as magnetic field concentration devices so that the gap 9 is penetrated by magnetic field lines which preferably leave and enter surfaces of the first electrode 7a which border the gap 9 approximately at right angles. In FIG. 4, the magnetic field in the region of the gap 9 is shown symbolically by three curved arrows which lie concentrically with respect to one another. At the same time, the magnetic field penetrates the first measuring device 12a. The first measuring device 12a is able to form an image of the magnetic field which has been concentrated by the first electrode 7a. A magnetic field is produced in the first electrode 7a by a current flow in the associated first phase conductor 5a. The magnetic field produced by a current flow in the first phase conductor 5a is concentrated in the first electrode 7a and also conducted through the gap 9. In doing so, the magnetic field constitutes an image of the current flow through the first phase conductor 5a, so that an electrical current flow through the associated first phase conductor 5a can be inferred by means of the first measuring device 12a. The first measuring device 12a can be a Hall sensor, for example, which can measure the magnetic field.

A voltage which drives a current flow through the first phase conductor 5a can electrically charge the first electrode 7a. The electrically conducting connection 11, which connects the first electrode 7a to the frame 3 which carries ground potential, enables a discharge by means of a discharge current flowing through the electrically conducting connection 11. The discharge current via the electrically conducting connection is a measure of the electrical voltage applied to the first phase conductor 5a.

Furthermore, a second measuring device 12b is provided, by means of which an image of a current flow through the electrically conducting connection 11 can be produced. In the present case, a tapping of the current flowing in the electrically conducting connection by means of a transformer effect is shown symbolically in FIG. 4. Alternatively, a different measuring principle can be used instead of the transformer effect principle. For example, an image of an electrical voltage on the first phase conductor 5a can be produced by the second measuring device 12b by optical measurement or by measurement using Hall probes. Furthermore, the discharge current can also be measured outside the pocket 10, for example in a ground current path.

Signal cables of the first and second measuring device 12a, 12b are fed to the outside through the access opening 6a in the frame 3. FIG. 5 shows a section lying perpendicular to the plane of the drawing of FIG. 4.

FIG. 6 shows an alternative embodiment of an insulator arrangement, wherein the insulator arrangement has only a single phase conductor 5d. The phase conductor 5d is aligned coaxially with respect to a main axis 2 and embedded in an insulating body 1a. The insulating body 1a is enclosed by a frame 3a. Apart from the position of the single phase conductor 5d and the number of access openings in the frame 3a, a perspective view of the embodiment shown in FIG. 6 is hardly any different in principle from the insulator arrangement shown in FIG. 1.

In FIG. 6, a single-phase embodiment of an insulator arrangement is shown in cross section by way of example. A fourth electrode 7d is arranged coaxially with respect to the single phase conductor 5d. In principle, the fourth electrode 7d corresponds to the structure of the electrodes as shown in

FIGS. 2, 3, 4 and 5. The fourth electrode 7d is arranged coaxially with respect to the main axis 2 and therefore coaxially with respect to the single phase conductor 5d. The frame 3a is likewise aligned coaxially with respect to the main axis 2. In the present case, the position of a gap in the fourth electrode 7d is indicated symbolically by means of a block 8. As the frame 3, the fourth electrode 7d and the single phase conductor 5d are aligned coaxially with respect to one another, a position of the gap can be fixed almost anywhere in the circumferential direction.

The above comments relating to the exemplary embodiment according to FIGS. 1, 2, 3, 4 and 5 apply in a similar manner to the principle of operation, design of the gap, a pocket, measuring devices etc. for the alternative embodiment of an insulator arrangement according to FIG. 6.

1-17. (canceled)

18. An insulator arrangement, comprising:
an insulating body having a first face side and a second face side;
at least one phase conductor penetrating said insulating body in a direction of a main axis from said first face side to said second face side;
an electrode encompassing said at least one phase conductor substantially perpendicular to the main axis;
said electrode being penetrated by a gap formed to interrupt a completely closed circumference of said electrode.

19. The insulator arrangement according to claim 18, wherein said gap is formed to completely penetrate said electrode.

20. The insulator arrangement according to claim 18, wherein said gap penetrates said electrode in a radial direction.

21. The insulator arrangement according to claim 18, wherein a blind-hole pocket extends in a direction of said gap and opens out into one of the sleeve surfaces connecting said first and second face sides of said insulating body.

22. The insulator arrangement according to claim 18, which comprises an electrically conducting connection penetrating said insulating body and configured to make contact with said electrode.

23. The insulator arrangement according to claim 18, which comprises an electrically conducting frame enclosing said insulating body, and an electrically conducting connection connecting said frame to said electrode.

24. The insulator arrangement according to claim 23, wherein said electrically conducting frame is a metal frame.

25. The insulator arrangement according to claim 22, wherein said electrically conducting connection makes contact with said electrode in a region of said gap.

26. The insulator arrangement according to claim 18, which comprises a magnetic field measuring device protruding into said gap.

27. The insulator arrangement according to claim 22, which comprises a current measuring device disposed on said electrically conducting connection.

28. The insulator arrangement according to claim 18, wherein said at least one phase conductor and said electrode are coaxially aligned with respect to the main axis.

29. The insulator arrangement according to claim 18, wherein said at least one phase conductor is one of a plurality of phase conductors distributed along a circular path about the main axis, and each of said phase conductors penetrates said insulating body and is encompassed by an electrode substantially perpendicular to the main axis.

30. The insulator arrangement according to claim 29, wherein each of said electrodes is penetrated by a gap running substantially radially with respect to the main axis.

31. The insulator arrangement according to claim 18, wherein each of said electrodes is completely enclosed by said insulating body.

32. The insulator arrangement according to claim 23, wherein said electrically conducting frame runs coaxially around the main axis.

33. The insulator arrangement according to claim 18, wherein said electrode is completely enclosed by the insulating body.

34. The insulator arrangement according to claim 18, wherein said at least one phase conductor forms an angularly rigid bond with said insulating body.

35. The insulator arrangement according to claim 18, wherein said insulating body is a disk-shaped insulating body.

36. The insulator arrangement according to claim 18, wherein said insulating body is formed with profiling.

37. The insulator arrangement according to claim 23, wherein said frame is formed to enable access to a blind-hole pocket extending in a direction of said gap and opening out into one of the sleeve surfaces connecting said first and second face sides of said insulating body.
